(19) United States
(12) Patent Application Publication
(10) Pub. No.: US 2015/0170276 A1
(43) Pub. Date: Jun. 18, 2015

(54) INTERCONNECTED NETWORK OF ONLINE SECURITIES OFFERING PLATFORMS

(71) Applicant: SeedInvest, LLC, New York, NY (US)

(72) Inventors: Sashi Kiran Lingam, New York, NY (US); Ryan Michael Feit, New York, NY (US); James Han, New York, NY (US); Harshil Mukesh Shah, Woodbridge, NJ (US); Homan Lee, Long Island, NY (US)

(21) Appl. No.: 14/330,554

(22) Filed: Jul. 14, 2014

Related U.S. Application Data
(60) Provisional application No. 61/846,417, filed on Jul. 15, 2013.

(51) Int. Cl. G06Q 40/04

(52) U.S. Cl. CPC G06Q 40/04

(57) ABSTRACT

Disclosed are various embodiments for maintaining an interconnected network of platforms via a securities offering application. The interconnected network of platforms may comprise a master platform and at least one sub-platform. Each platform may be used to access or facilitate an offering for a plurality of securities over a network, thereby allowing issuing entities to raise capital. A first investment organization may syndicate a deal to a second investment organization. The securities offering application may further maintain a plurality of collaboration components accessible by the users to communicate across the interconnected network of platforms.

### CROSS-REFERENCE TO RELATED APPLICATION

This application claims the benefit of and priority to U.S. Provisional Patent Application Ser. No. 61/846,417 entitled “COMPUTER SYSTEM AND METHOD FOR HOSTING SEPARATE PRIVATE INVESTMENT SUB-PLATFORMS FOR GROUPS; FACILITATING SYNDICATION AMONG SUCH GROUPS; AND MANAGING INVESTMENTS AND SHAREHOLDERS ON AN INTEGRATED MASTER PLATFORM,” filed Jul. 15, 2013, which is incorporated by reference herein in its entirety.

### BACKGROUND

A security is a tradable financial asset which may assume the form of a debt security, an equity security, or a derivative security. The Jumpstart Our Business Startups (JOBS) Act of 2012 eased restrictions for securities offerings under the Securities Act of 1933. Businesses are now permitted to raise capital by offering equity securities over the Internet, enticing potential buyers to provide all or a portion of the capital needed by the businesses. Although the restrictions have been eased, enticing potential buyers to purchase equities remains problematic.

### SUMMARY

Disclosed are various embodiments for maintaining an interconnected network of platforms via a securities offering application. The interconnected network of platforms may comprise a master platform and at least one sub-platform. Each platform may be used to access or facilitate an offering for a plurality of securities over a network, thereby allowing issuing entities to raise capital. A first investment organization may syndicate a deal to a second investment organization. The securities offering application may further maintain a plurality of collaboration components accessible by the users to communicate across the interconnected network of platforms.

### BRIEF DESCRIPTION OF THE DRAWINGS

Many aspects of the present disclosure may be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a relationship created between a securities offering application and data stored in a data store.

FIG. 2 is a networked environment comprising the securities offering application and the data store according to various embodiments of the present disclosure.

FIGS. 3A-B illustrates the relationships between the securities offering application and a plurality of interconnected platforms according to various embodiments of the present disclosure.

FIG. 4 is one example of a user interface rendered by a client device in the networked environment of FIG. 2 according to various embodiments of the present disclosure.

FIG. 5 is one example of a user interface rendered by a client device in the networked environment of FIG. 2 according to various embodiments of the present disclosure.

FIG. 6 is one example of a user interface rendered by a client device in the networked environment of FIG. 2 according to various embodiments of the present disclosure.

FIG. 7 is a flowchart illustrating one example of functionality implemented as portions of the securities offering application executed in a computing environment in the networked environment of FIG. 1 according to various embodiments of the present disclosure.

FIG. 8 is a schematic block diagram that provides one example illustration of a computing environment employed in the networked environment of FIG. 2 according to various embodiments of the present disclosure.

### DETAILED DESCRIPTION

The present disclosure relates to an interconnected network of securities offering applications or similar platforms, each platform configured to facilitate an offering of securities for one or more business entities (e.g., such as a company or investment fund seeking to raise capital through the offering of its securities, hereinafter referred to as an “issuer” or “issuing entity”). The network of platforms may comprise a master application or platform and one or more sub-platforms associated with one or more groups. Each sub-platform may have a distinct user base and administrator, while the master platform may operate and have administrator rights over the entire network, including all of the sub-platforms. As discussed above, the Jumpstart Our Business Startups (JOBS) Act of 2012 eased restrictions for securities offerings under the Securities Act of 1933. Businesses are now permitted to raise capital by offering securities over the Internet to entice buyers to provide all or a portion of the capital needed by the businesses or investment funds.

For example, a group or an entity, such as a university, an industry group, a broker-dealer, startup accelerator, angel group, venture capital fund, etc., may desire to operate a sub-platform (wherein each operator of a sub-platform is hereinafter referred to as a “group”) to allow issuers or issuing entities within their network of customers to conduct securities offerings online using the sub-platform. The securities offerings may include offerings to accredited investors pursuant to Rule 506(c) of Regulation D, any other securities exemption, or an effective registration statement. As will be described herein, a securities offering application is configured to maintain a network presence of an issuer and/or a group to conduct a securities offering over a network without the issuer and/or group having to create a proprietary securities offering platform. Accordingly, the securities offering application may provide a “sub-platform” for each group, thereby allowing each group, group's affiliates, and/or customers to offer securities using the infrastructure provided by the sub-platform. The securities offering application may comprise several safeguards to reduce fraud and to facilitate regulatory compliance.

According to various embodiments, a computing environment, comprising at least one computing device, is configured to execute a securities offering application that maintains a network presence of a group or entity, which maintains a plurality of issuers on the applicable sub-platform offering a plurality of securities for purchase. To this end, the securities offering application may maintain a network page for the group and issuer, such as a web page or a mobile application user interface, which is accessible over a network. The network page or user interface for each issuer or issuing entity may be configured to facilitate at least one purchase of the securities by at least one user of the securities offering application. The securities offering application executable in the computing environment may be further configured to determine whether a number of the securities purchased meets a predefined threshold. According to various embodiments, the predefined threshold may be configurable by an administrator of the entity via the security offering application. As may be appreciated, the predefined threshold may comprise a funding target or a funding goal set forth by the administrator of the entity via the securities offering application.

The securities offering application, or a recommendation service in communication with the securities offering application, is configured to recommend the network page that offers the securities for purchase to at least one investment organization registered in the securities offering application. The recommendation to the at least one investment organization may be made automatically without requiring input from an administrator, as will be described in greater detail below. Further, the recommendation to the at least one investment organization may be conditional on whether the number of the securities purchased meets the predefined threshold. In the following discussion, a general description of the system and its components is provided, followed by a discussion of the operation of the same.

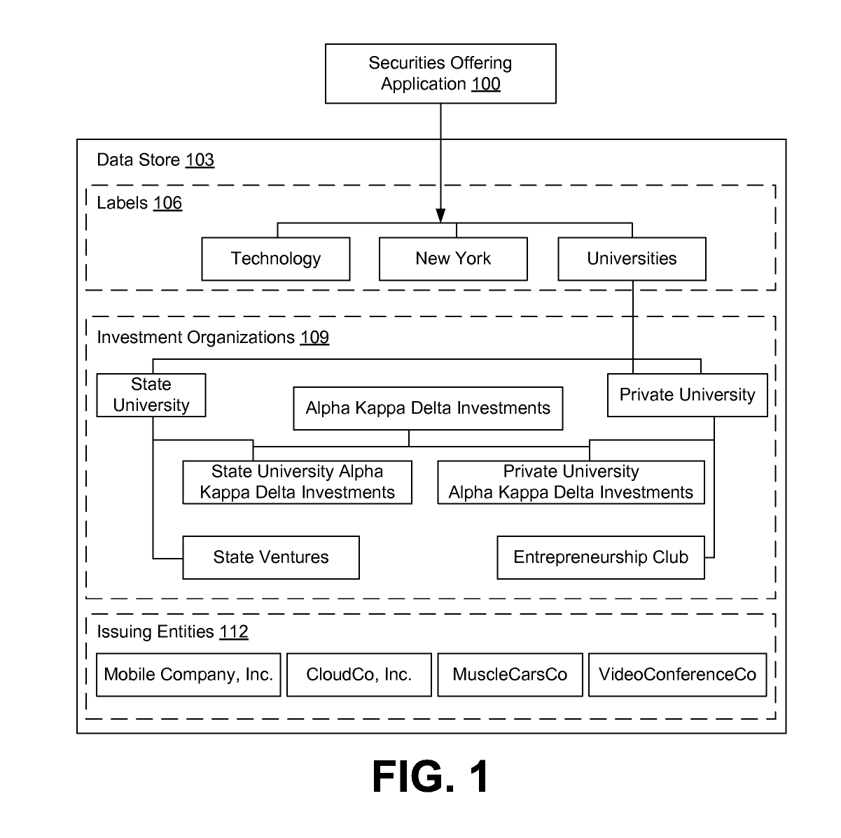

With reference to FIG. 1, there is shown is a drawing depicting a relationship between a securities offering application 100 and data stored in a data store 103. As illustrated in the non-limiting example of FIG. 1, the data store 103 includes a plurality of labels 106, a plurality of investment organizations 109, and a plurality of issuing entities 112 all of which may be stored in the data store 103 as a database (e.g., comma separated value [CSV] database, structured query language [SQL] database, etc.) or in a similar fashion. The investment organizations 109 may be associated with real-world investment organizations such as the Private University Alpha Kappa Delta organization or the Private University Entrepreneurship Club, both of which are associated with the Private University in the data store 103.

To this end, the labels 106 include tags, keywords, lexicons, symbols, etc., that may represent or describe one of the investment organizations 109 or one of the issuing entities 112 offering securities for purchase via the securities offering application 100. For example, the label 106 designated “Universities” may describe the “State University” investment organization 109 and the “Private University” investment organization 109 wherein “Technology” and “New York” are labels 106 that describe various entities that are not shown in FIG. 1. Similarly, the labels 106 may be used to describe the issuing entities 112 offering securities for purchase via the securities offering application 100, as opposed to an investment organization 109. The labels 106 stored in the data store 103 may be used to compare an investment organization 109, such as an investment company, to an issuing entity 112 offering securities, such as a technology startup. The use of the labels 106 will be discussed in greater detail below.

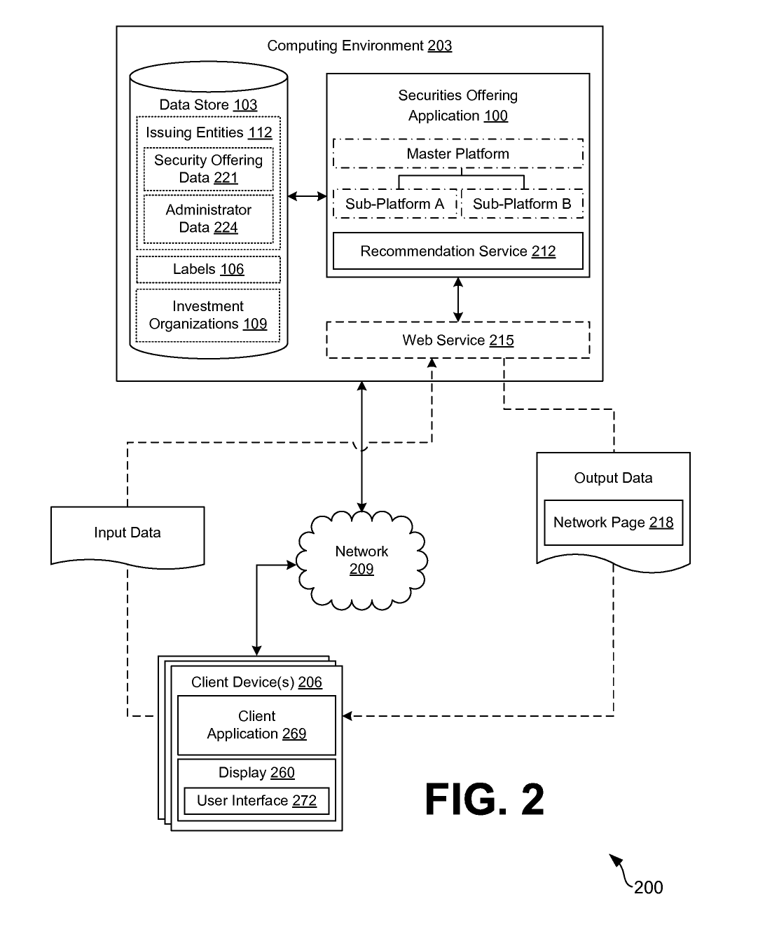

With reference to FIG. 2, shown is a networked environment 200 according to various embodiments. The networked environment 200 includes a computing environment 203 and a client device 206, which are in data communication with each other via a network 209. The network 209 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in the data store 103 that is accessible to the computing environment 203. The data store 103 may be representative of a plurality of data stores 103 as can be appreciated. The data stored in the data store 103, for example, is associated with the operation of the various applications and/or functional entities described below.

The components executed on the computing environment 203, for example, include the securities offering application 100, a recommendation service 212, a web service 215, and other applications, services, processes, systems, engines, or functionality not discussed in detail herein. The securities offering application 100 is executed in order to facilitate the online purchase of securities over the network 209 by offering a master platform (e.g., http://www.investmentplatform.site) and one or more sub-platforms for an entity (e.g., http://www.investmentplatform.site/entity). The securities offering application 100 also performs various backend functions associated with the online presence of an entity in order to facilitate the online purchase of securities offered by the entity as will be described. For example, the securities offering application 100 generates network pages 218 such as web pages or other types of network content that are provided to client devices 206 for the purposes of selecting and negotiating the purchase of securities.

The recommendation service 212 is executed to identify investment organizations 109 that are potentially interested in a securities offering by an issuing entity 112. To this end, the recommendation service 212 may compare a first plurality of labels 106 associated with the issuing entity 112 to a second plurality of labels 106 associated with the investment organization 109. For example, if the issuing entity 112 is associated with a label 106 for “cloud computing,” the securities offering may be suggested to investment organizations 109 also associated with a label 106 for “cloud computing” and/or labels 106 similar to “cloud computing” such as “distributed computing.”

The data stored in the data store 103 includes, for example, data corresponding to one or more issuing entities 112, investment organizations 109, labels 106, and potentially other data. Data for the issuing entities 112 may include, for example, security offering data 221 and administrator data 224. Security offering data 221 may comprise an amount of securities the issuing entity 112 is willing to offer, a price per security, and/or other information associated with a security offering. Administrator data 224 may comprise information used to authenticate an administrative user (e.g., an administrator).

The client device 206 is representative of a plurality of client devices 206 that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 206 may include a display 260. The display 260 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 269 and/or other applications. The client application 269 may be executed in a client device 206, for example, to access network content served up by the computing environment 203 and/or other servers, thereby rendering a user interface 272 on the display 260. To this end, the client application 269 may comprise, for example, a browser, a dedicated application such as a mobile application, etc., and the user interface 272 may comprise a network page, an application screen, etc. The client device 206 may be configured to execute applications beyond the client application 269 such as, for example, e-mail applications, social networking applications, word processors, spreadsheets, and/or other applications.

Next, a general description of the operation of the various components of the networked environment 200 is provided. To begin, it is assumed that an issuing entity 112, such as a technology startup, desires to obtain capital by selling securities via the securities offering application 100. Accordingly, an administrator for the issuing entity 112, registered in the securities offering application 100, may access the securities offering application 100 to provide information associated with the issuing entity 112, such as a location, a description of the issuing entity 112, a business plan, investors, company leaders, etc. The information provided by the administrator may be used in the generation of the user interface 272 (e.g., the network page 218) for the issuing entity 112. Further, the administrator for the issuing entity 112 may define an amount of securities the issuing entity 112 is willing to offer as well as a price per security. To this end, the administrator may configure the network page 218 generated by the securities offering application 100 on behalf of the issuing entity 112. The network page 218 may include a component that initiates the purchase of the securities by various users of the securities offering application 100.

The securities offering application 100 generates the network pages 218 as well as monitors the purchases of the securities for the issuing entity 112. In addition, the securities offering application 100 maintains an interconnected network of platforms comprising, for example, a master platform managed by a master administrator of the securities offering application 100 and one or more sub-platforms. As will be described in greater detail below, each sub-platform may comprise one or more network pages accessed by a unique network address and associated with a particular investment organization 109.

Further, the securities offering application 100 can be described as maintaining a network presence for the issuing entity 112 offering securities for purchase as it generates a network page 218 on behalf of the issuing entity 112, facilitates the purchase of the securities, conducts the financial transaction (e.g., takes purchase money from the buyer and gives the purchase money to the issuing entity 112), and monitors the funding target for the issuing entity 112. In various embodiments, the securities offering application 100 may parse a description for the issuing entity 112 and/or an investment organization 109 to automatically assign one or more labels 106 to the issuing entity 112 or to the investment organization 109. The parsing of the descriptions may be performed periodically at predefined intervals to maintain an accurate listing of the labels 106 in the data store 103 for each issuing entity 112 or investment organization 109.

As a non-limiting example, a sentence or a phrase set forth in a profile for an issuing entity 112 or an investment organization 109 may state “developing cloud computing storage solutions of the future” or “investing in cloud computing companies of the future.” The phrase may be parsed to identify that the issuing entity 112 or the investment organization 109 should be associated with the label 106 corresponding to “cloud computing” as the term appears in the phrase. Accordingly, an association between the label 106 and the issuing entity 112 or the investment organization 109 may be made in the data store 103. In place of or in addition to, labels 106 may be manually added or removed by the administrator of the issuing entity 112 or the investment organization 109. In addition, the labels 106 associated with an investment organization 109 may be based at least in part on a previous purchase in which the investment organization 109 purchased at least one security.

The securities offering application 100 monitors the purchases of securities of behalf of the issuing entity 112. For example, the administrator of an issuing entity 112 may set a funding target of selling 100,000 equity securities at $10 per equity to obtain $1,000,000 in financing. The securities offering application 100 may monitor the purchases of the equity securities to determine whether the funding target has been met. If the number of securities purchased does not meet or exceed the funding target set forth by the administrator, the securities offering application 100 may employ strategies to provide exposure to the securities offering on behalf of the issuing entity 112.

According to various embodiments, one or more investment organizations 109 may be identified that are similar to the issuing entity 112 offering the securities. Identifying the one or more investment organizations 109 may be accomplished by comparing a first plurality of labels 106 associated with the issuing entity 112 to a second plurality of labels 106 associated with the investment organization 109. For example, if the issuing entity 112 is associated with a label 106 for “cloud computing,” the securities offering may be suggested to investment organizations 109 also associated with a label 106 for “cloud computing” and/or labels 106 similar to “cloud computing” such as “distributed computing.” As another example, if the issuing entity 112 is associated with the label 106 for “New York” (as the issuing entity 112 has previously stated that the issuing entity 112 is based in New York), the securities offering may be suggested to investment organizations 109 that invest in New York companies, such as the “New York Angel Investors” and similar entities, groups, or organizations.

To this end, the securities offering for the issuing entity 112 may be recommended to the identified investment organizations 109. Recommending the securities offering may include, for example, placing a component, such as a hyperlink, an advertisement, or a banner on a member page for the investment organizations 109, whereby the component is shown to the members of the investment organizations 109. For example, assuming a member of the “New York Angel Investors” logs in to the securities offering application 100, the display page for the investment organization 109 may contain a hyperlink, an advertisement, a banner, or a similar component that links to the network page 218 associated with the security offering by the issuing entity 112.

In alternative embodiments, recommending the securities offering to the identified investment organizations 109 may comprise sharing a network address (e.g., a uniform resource locator [URL]) of the securities offering via a social network, e-mail, or short message service (SMS).

In various embodiments, the securities offering application 100 conducts syndication on behalf of an investment organization 109 for particular offerings. In various embodiments, syndication of a particular offering may comprise collecting votes or similar feedback to determine whether the investment organization 109 should purchase all or a portion of the remaining securities available for purchase, or should place a hyperlink on a network page 218 for the investment organization 109 to the particular offerings. For example, the members of the investment organization 109 may engage an “upvote” component or a “downvote” component in the member page that is associated with the hyperlink to crowdsource votes among its members as to whether the members like or dislike the securities offering. Assuming a favorable amount of votes have been obtained in association with the offering of the securities, the offering may be syndicated by the investment organization 109.

In alternative embodiments, syndication of a particular offering comprises a decision by an administrator of an investment organization 109 of a sending group or investment organization 109 and a receiving group or investment organization 109 in collaboration with the issuing entity 112. For example, if Atlanta Angel Investors are investing in a particular issuing entity 112 and they believe New York Angel Investors would be interested in looking at the deal also, then Atlanta Angel Investors may contact the issuing entity 112 to see if they would like the deal to be referred to the New York Angel Investors. If the issuing entity 112 and the investment organization 109 agree (e.g., via administrators and/or members), then the sending investment organization 109 (e.g., Atlanta Angel Investors) would “syndicate” the deal to the receiving investment organization 109 (e.g., New York Angel Investors).

To this end, members of the investment organization 109 may suggest a specific investment opportunity to the group. Administrators can then approve or reject such an investment opportunity for viewing by the general group membership or may place the investment opportunity up for syndication. The securities offering application 100 may also impose certain technical requirements prior to an investment opportunity being eligible for approval, including, but not limited to: (i) requiring each issuing entity 112 to execute a standard terms of service for issuing entities 112 as in effect at such time and acknowledge the terms of use of the securities offering application 100; (ii) confirming that a background check has been conducted and is available to users; (iii) requiring a certain number of social media followers or references; (iv) requiring a certain number of expressions of investment interest; and/or (v) other requirements that may be imposed for participation and monitored by the securities offering application 100.

Once a deal is suggested by a user associated with the investment organization 109, the issuing entity 112 may be prompted to complete an issuer profile on the securities offering application 100 if they have not previously created such a profile. Upon approval by an administrator, the securities offering may be made available for viewing by users and a due diligence process, discussed below, may begin. An administrator may designate that certain group members are able to manage a specific securities offering. Each approved securities offering will have separate deal-specific network pages 218 within the member page, as further described below.

Pursuant to regulations proposed by the Securities and Exchange Commission (the “SEC”), issuing entities 112 will be able to generally solicit and/or advertise their securities offerings to the general public so long as they take reasonable steps to verify that any purchasers are accredited investors. In addition, the SEC may impose certain other filing requirements in order to take advantage of these new rules, including, but not limited to: (i) making an advance Form D filing a certain number of days prior to making any general solicitation; (ii) filing any general solicitation materials with the SEC on the SEC website on or prior to the date of such general solicitation; (iii) filing of a closing Form D amendment within 30 calendar days after the termination of a Rule 506 offering, as described in SEC Release No. 33-9416; Release No. 34-69960; Release No. IC-30595; File No. S7-06-13, available at http://www.sec.gov/rules/proposed/2013/33-9416.pdf; (iv) annual Form D amendments while an offering is ongoing; and (5) limiting the content of marketing materials used by “private funds.”

The securities offering application 100 can generate these required forms on behalf of issuing entities 112, provide for automatic electronic submission of the appropriate filing to the appropriate government agency, and provide checks and safeguards to ensure that appropriate filings have been made prior to allowing any general solicitation to be conducted on the securities offering application 100.

Each user, investment organization 109, or issuing entity 112 with the applicable permission, shall have the ability to share securities offerings with other users, investment organizations 109, or issuing entities 112 on the securities offering application 100. Accordingly, if a member of an investment organization 109 is considering a security offering by an issuing entity 112 and believes that another user or investment organization 109 may also have interest, the member can manipulate a “syndicate” component (e.g., a button) and automatically have the deal appear in the other user's deal funnel on the member page of the receiving user or investment organization 109. The administrators for the receiving user or investment organization 109 may then determine whether to decline or share such securities offerings with their members. Once shared, members of the investment organization 109 will have access to a “deal network page” for the securities offering. Issuing entities 112 may also apply to syndicate their securities offerings to the users of the securities offering application 100 following the same procedure.

Each issuing entity 112 may have a separate private communication channel separate from any other issuing entities 112 looking at syndicated securities offerings on the securities offering application 100. Each investment organization 109 or issuing entity 112 may be able to, using the securities offering application 100, electronically set separate terms of investment for a particular investment opportunity or separately pool their investments via a separate investment vehicle. This may include a backend system whereby an entry is made into the data store 103 for an individual investment opportunity for a particular issuing entity 112. Upon syndication, another entry for the same investment opportunity is created for the receiving issuing entity 112 such that the receiving investment organization 109 may be able to manage and communicate about the investment opportunity separately from the sending entity 112 or sending investment organization 109. An issuing entity 112 may syndicate a deal to a particular individual investor, who would then be added to a team for the issuing entity 112.

The securities offering application 100 may also facilitate the creation of a committee for each syndicated deal, where members of the committee of each investment organization 109 or issuing entity 112 can separately communicate with each other regarding a particular investment opportunity or securities offering. This allows each committee to conduct due diligence and negotiate terms collectively with committees from other investment organizations 109 or issuing entities 112.

The securities offering application 100 can provide the following capabilities to issuing entities 112, users, and investment organizations 109 for the purpose of facilitating and managing the due diligence process, including, but not limited to, the issuing entity 112 being able to: (i) upload due diligence and transactional documentation; (ii) hold live due diligence webcasts; (iii) conduct questions and answer sessions with investors on its respective network page 218; (iv) control privacy settings to regulate which members will have access to which information; (v) separate due diligence communication channels to privately discuss securities offerings separately from the issuing entity 112; (vi) enable the use of tools to both issuing entity 112 and investment organization 109 members; (vii) use any components or tools provided by securities offering application 100 for each securities offering facilitating the use of standardized form documents (such as a Note Purchase Agreement, Stock Purchase Agreement, Operating Agreement); and (viii) upload their own customized and negotiated transaction documents to the securities offering application 100.

The issuing entity 112 and the members of the investment organization 109 may or may not collectively decide on how to structure the investment, including but not limited to whether to structure the investment as direct investments or to form a holding company or a separate investment vehicle for the sole purpose of investing in the single issuing entity 112. The securities offering application 100 may be configured to track and store individual turns of the transaction documentation (including redlines reflecting changes) such that all of the deal data is stored in the data store 103 as an accessible repository. The securities offering application 100 may also copy a deal specific e-mail address on their e-mail distribution of transaction documents such that documents are automatically uploaded into a transaction document section accessible via the members page.

If a member of the investment organization 109 is ready to invest in a particular securities offering, it may initiate the investment process by clicking on an “invest” component (e.g., a button or a hyperlink) encoded by the securities offering application 100. According to various embodiments, the “invest” component may be encoded on a deal network page 218 or on a profile page for an issuing entity 112 and/or any other user interface 272. As a non-limiting example, the investment process performed by the securities offering application 100 includes: (i) confirming an identity of a user; (ii) confirming an accredited investor status of a user; (iii) prompting the user to review and electronically sign relevant legal investment documents (such as a stock purchase agreement or an operating agreement); (iv) prompting the user to enter bank account information or other financial information to fund the investment; (v) transferring funds directly to an account designated by the issuing entity 112 (either directly to an account of the issuing entity 112 or to an escrow account provided by the issuing entity 112); (vi) generate and send a confirmation page and copies of the relevant investment documents; and/or (vii) electronically close the securities offerings. If an escrow account is used, funds may be distributed by the escrow agent in accordance with payment instructions from the issuing entity 112. Payment processes may provide for direct payment of legal fees and other transaction expenses directly to the appropriate vendors. Final executed transaction documents may be sent from the securities offering application 100 to the issuing entity 112 and participating users and shall be available for review in a personal portfolio page generated for each investment organization 109 or each user. Further, any stock certificates or other physical securities to be issued to the user shall be done directly by the issuing entity 112 (or their legal counsel) to the user.

Each user or member of an investment organization 109 may view and manage its investment documents made on the securities offering application 100 at any time. Further, each user or member may view their transaction history and related transaction documents; track returns and access analytics related to their investments; track and analyze their deal funnel curation effectiveness; track and analyze a funding round and syndication for an issuing entity 112; and/or track and analyze participation amongst users.

Following the closing of a securities offering, issuing entities 112 can use the securities offering application 100 to communicate, manage, and extract value from their investors and other shareholders via a virtual board room system. This system provides functionalities that include sharing company updates, holding live stream information sessions, holding board meetings, polling and collecting opinions and votes on issues, collecting signatures from users, and/or requesting updates from the issuing entities 112.

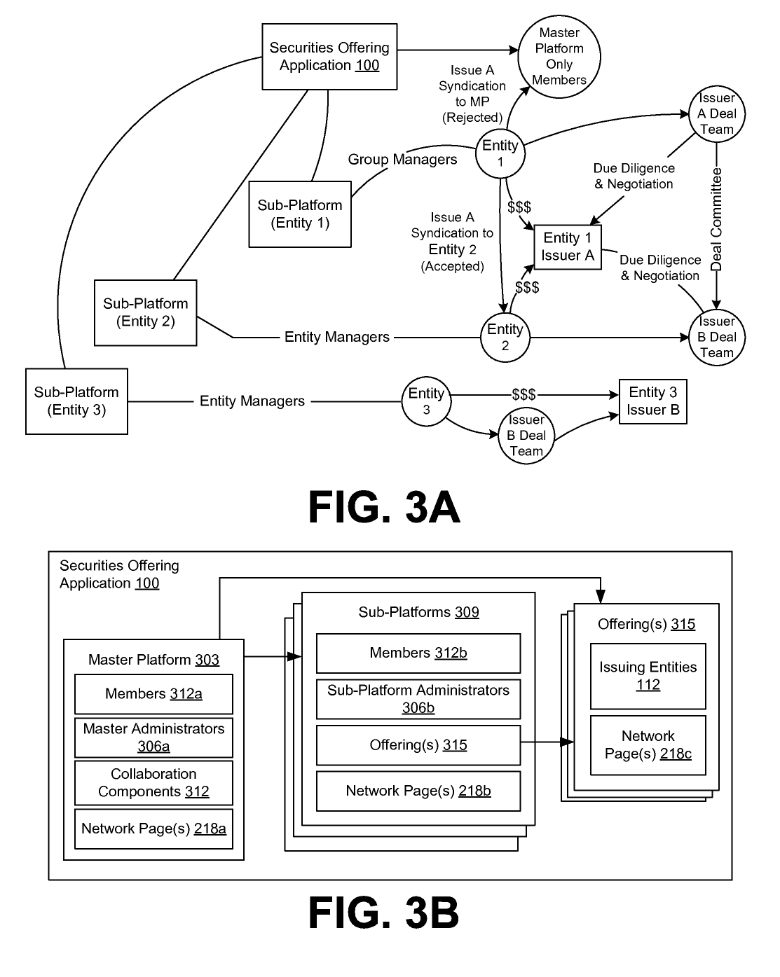

Moving on to FIG. 3A, shown are the relationships between the securities offering application 100 controlling a master platform and a plurality of sub-platforms for each of the issuing entities 112. The master platform may comprise one or more network pages 218 accessed by a network address that facilitate a viewing and/or selection of one of more offerings. To this end, the master platform may or may not have its own registered users. The securities offering application 100 is configured to allow each issuing entity 112 or investment organization 109, via a registered user, to create an area separate and/or private from the master platform controlled by the securities offering application 100 (referred to herein as a sub-platform), allowing each investment organization 109 and/or issuing entity 112 the ability to invite and manage their own members, propose investment transactions, and sign and close such investment transactions privately. Each sub-platform may be a separate and private area on the securities offering application 100 designated for the investment organization 109.

To this end, each investment organization 109 may have its own separate public profile (e.g., a “home page”) accessible via a publicly accessible network address (such as www.investplatform.site/[group_name] or groupname.investplatform.site). Each group may also have its own protected area accessible only to its verified members (“group members”). Further, each investment organization 109 may designate administrators or managers who are responsible for managing the memberships, approving or denying proposed investment transactions, appointing members of a particular deal team, and generally managing the sub-platform in the securities offering application 100. Each investment organization 109 can have all its members as administrators or none at all. The home page for the investment organizations 109 may comprise information about the investment organizations 109 such as a general description of the investment organizations 109, a list and/or pictures of sponsors, a list of members and administrators, and any other materials that the investment organizations 109 desire to post publicly.

Each user of the securities offering application 100 may be free to request to join multiple sub-platforms. Each sub-platform may share investment opportunities with other individuals, investment organizations 109, the securities offering application 100, or with its members which is referred to as “syndication” in FIG. 3 and described in greater detail below. Specifically, FIG. 3 illustrates an investment opportunity sourced by a first investment organization 109 (e.g., “Entity 1”) and syndicated and/or shared to a second investment organization 109 (e.g., “Entity 2”) and the securities offering application 100, with the second investment organization 109 participating in the investment.

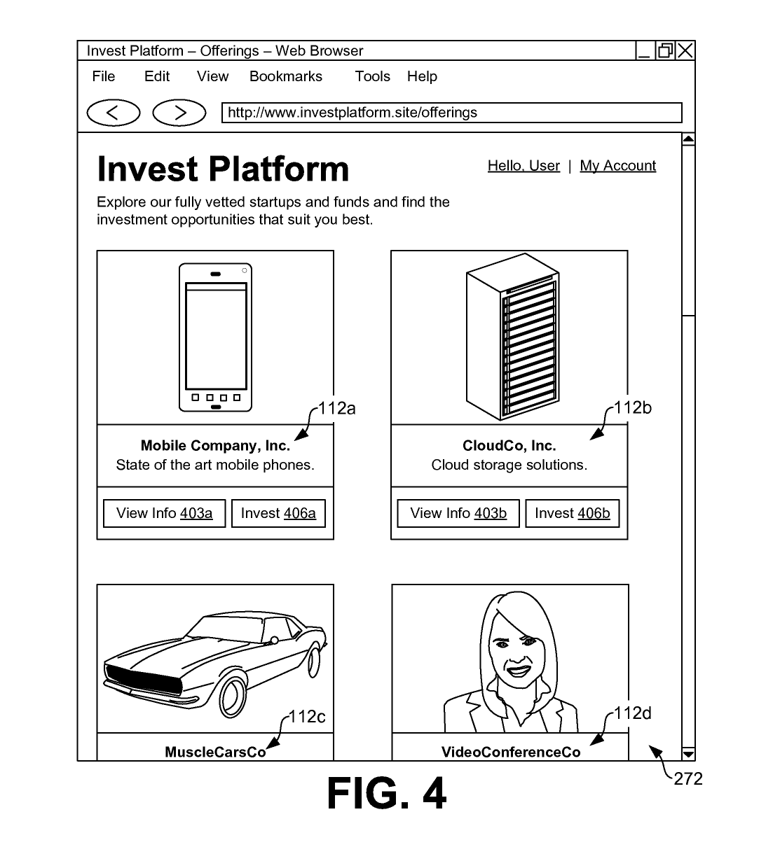

Turning now to FIG. 3B, shown is another example illustrating the relationships between the securities offering application 100 that maintains an interconnected network of platforms (e.g., a master platform and a plurality of sub-platforms for each of the issuing entities 112). The interconnected network of platforms comprises, for example, a master platform 303 managed, for example, by one or more master administrators 306 of the securities offering application 100. The master platform 303 may comprise one or more network pages 218a accessed by a unique network address. As will be shown in FIG. 4, the network page 218a of the master platform 303 is configured to display a plurality of security offerings as potential investment opportunities to visitors of the master platform.

The interconnected network of platforms further comprises one or more sub-platforms 309, wherein each of the sub-platforms 309 is associated with an investment organization 109. For example, a sub-platform 309 may exist for the Atlanta Angel Investors organization and a separate sub-platform 309 may exist for the New York Angel Investors organization. To this end, the sub-platform 309 may comprise one or more network pages 218b accessed by a unique network address. The one or more network pages 218b for the sub-platforms 309 may be configured to display at least one offering that is syndicated by a plurality of members 312 of the sub-platform 309.

The sub-platforms 309 may be associated with one or more offerings 315 for a plurality of securities made available for purchase by an issuing entity 112 over the network 209 via the securities offering application 100. In various embodiments, at least one of the offerings 315 may be made accessible via a network page 218c to facilitate a plurality of purchases of the securities by a plurality of users of the master platform or the sub-platforms.

According to various embodiments, the master platform 303 and the sub-platforms 309 may have distinct members 312, user bases, and/or administrators 306. In various embodiments, common user accounts may be used across platforms as well as common company profiles. Also, in various embodiments, the “best” ones of the offerings 315 may “bubble up” or surface to the network page 218a of the master platform 303 based on a popularity of the offerings 315 automatically via algorithmic selection or manually via human selection (e.g., by an administrator of the master platform 303). The surfacing of the offerings to the master platform is described in greater detail below.

Referring next to FIG. 4, shown is a drawing of an example user interface 272 rendered by the client device 206 (FIG. 2) in the networked environment 200 (FIG. 2) according to various embodiments of the present disclosure. In the non-limiting example of FIG. 4, the securities offering application 100 is accessed over the network 209 (FIG. 2) via a network address such as a URL. The securities offering application 100, via the user interface 272, may identify existing securities offerings whereby a user of the securities offering application 100 can navigate to network pages 218 associated with various issuing entities 112 to determine whether to purchase securities offered by the various issuing entities 112.

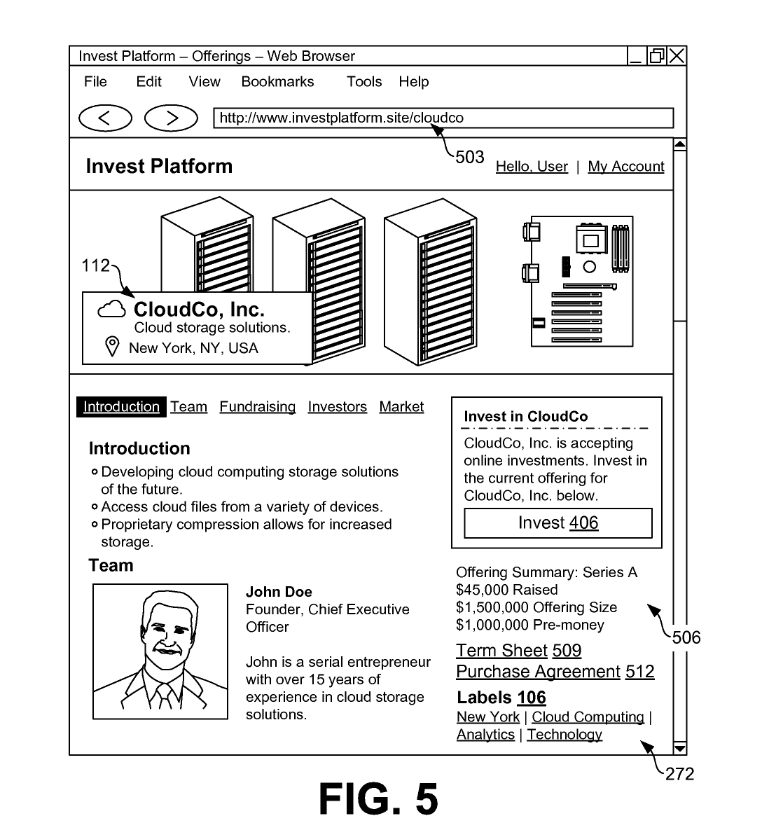

For example, in the user interface 272 of FIG. 4, a plurality of issuing entities 112a-d (collectively issuing entities 112) are shown offering securities in the securities offering application 100. The issuing entities 112 may be shown in association with an image, a brief description, a view information component 403a-b (collectively view information components 403), and an invest component 406a-b (collectively invest components 406). By manipulating the view information component 403, the user may be directed to the network page 218 corresponding to the issuing entity 112, as will be discussed in greater detail with respect to FIG. 5. Similarly, by manipulating the invest component 406, the user may be directed to the network page 218 corresponding to the issuing entity 112 or to a network page 218 that allows the user to carry out a purchase of the securities.

Turning now to FIG. 5, shown is a drawing of an example user interface 272 rendered by the client device 206 (FIG. 2) in the networked environment 200 (FIG. 2) according to various embodiments of the present disclosure. In the non-limiting example of FIG. 5, shown is a network page 218 corresponding to an issuing entity 112 offering a plurality of securities for purchase. As may be appreciated, the network page 218 may be accessed over the network 209 (FIG. 2) via a unique network address 503.

The network page 218 may comprise, for example, information associated with the issuing entity 112 that may be appealing to potential investors such as, but not limited to, a team working for the issuing entity 112, fundraising objectives, past or present investors, market research, business plans or strategies, an introduction video, etc. Further, the network page 218 may comprise information associated with the securities offering, as shown in the offering information component 506. For example, the issuing entity 112 may let potential purchasers know that the issuing entity 112 has previously raised $45,000, is offering $1,500,000 worth of securities, and has a $1,000,000 pre-money valuation. The network page 218 may direct the user to a term sheet via a term sheet hyperlink 509 or a purchase agreement via a purchase agreement hyperlink 512.

The network page 218 may comprise a plurality of labels 106 or tags predefined by the administrator, automatically assigned by the securities offering application 100, or a combination thereof. By manipulating one of the labels 106, subsequent user interfaces 272 may be rendered showing other securities offerings associated with the manipulated one of the labels 106 and/or showing investment organizations 109 associated with the manipulated one of the labels 106.

The invest component 406, when manipulated by a user, may generate subsequent user interfaces 272 that facilitate the purchase of all or a portion of the securities offered by the issuing entity 112. To this end, the securities offering application 100 may collect financial information (e.g., electronic wire information, credit card information, etc.) from the user and prompt the user to agree to the term sheet and the purchase agreement in order to maintain legal compliance involved with the transaction. A financial transaction may be initiated where the purchase money provided by the user is placed in escrow or deposited to an account associated with the issuing entity 112.

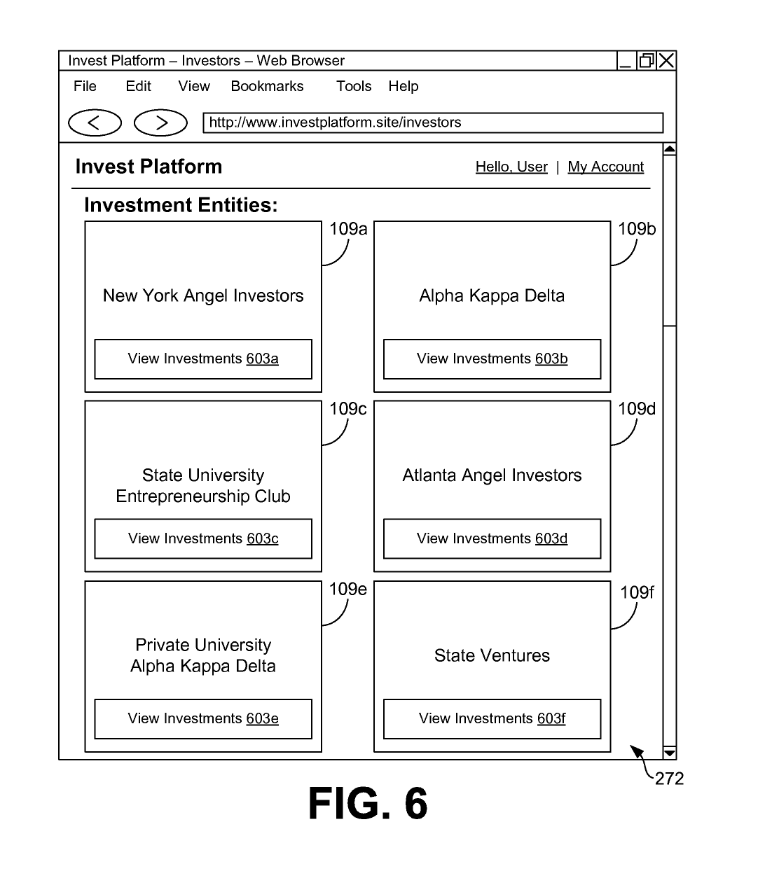

Moving on to FIG. 6, shown is a drawing of an example user interface 272 rendered by the client device 206 (FIG. 2) in the networked environment 200 (FIG. 2) according to various embodiments of the present disclosure. In the non-limiting example of FIG. 6, shown are a plurality of investment organizations 109a-f (collectively investment organizations 109) registered in the securities offering application 100. As discussed above, the investment organizations 109 may have proprietary sub-platforms comprising network pages 218 that allow users to access information associated with the investment organizations 109. Similarly, the users may access past or present investments conducted by an investment organization 109, or other information associated with the sub-platform, by engaging a corresponding one of the view investments components 603a-f (collectively view investments components 603) in the user interface 272.

Accordingly, the master platform maintained by the securities offering application 100 may be described as establishing an interconnected network between the master platform and the sub-platforms or among the sub-platforms themselves. According to various embodiments, investor information can be used across the platforms such that a master account can be used to access investor information across the platforms. Deal information, or information related to an offering, can be used across the platforms via a syndication process, whereby a company takes their profile or network page 218 from one sub-platform to another. In addition, central tech support and compliance infrastructure may be offered (e.g., online tech support chat, forums, etc.).

Further, the securities offering application 100 may offer certain collaboration tools to the administrators of each third party investment organization 109 (or sub-platform), such as chat rooms, forums, email communication tools, leaderboards, performance statistics, reporting dashboards, question and answer functionality, profile pages, etc., each for the purpose of creating a community or facilitating interaction among such administrators.

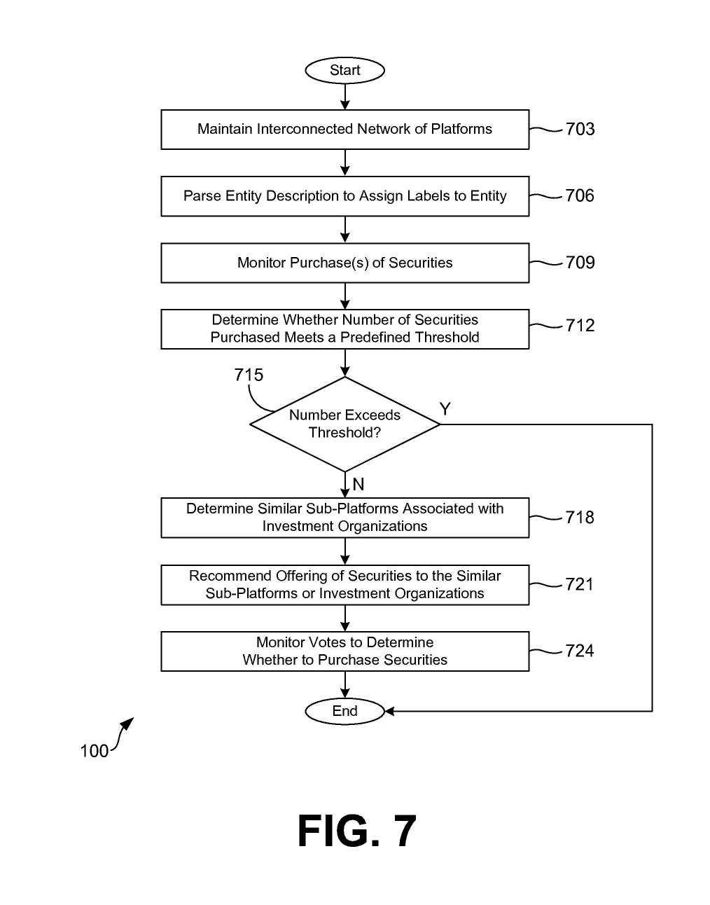

Referring next to FIG. 7, shown is a flowchart that provides one example of the operation of a portion of the securities offering application 100 and/or the recommendation service 212 (FIG. 2) according to various embodiments. It is understood that the flowchart of FIG. 7 provides merely an example of the many different types of functional arrangements that may be employed to implement the operation of the portion of the securities offering application 100 as described herein. As an alternative, the flowchart of FIG. 7 may be viewed as depicting an example of elements of a method implemented in the computing environment 203 (FIG. 2) according to one or more embodiments.

Beginning with 703, the securities offering application 100 maintains an interconnected network of platforms, the interconnected network of platforms comprising, for example, a master platform managed by a master administrator. The master platform may comprise one or more network pages 218 accessed by a unique network address. As shown in FIG. 4, the network page 218 of the master platform is configured to display a plurality of offerings.

The interconnected network of platforms further comprises one or more sub-platforms, wherein each of the sub-platforms is associated with an investment organization 109. For example, a sub-platform may exist for the Atlanta Angel Investors organization and a separate sub-platform may exist for the New York Angel Investors organization. To this end, the sub-platform may comprise one or more network pages accessed by a unique network address. The one or more network pages for the sub-platforms may be configured to display at least one offering that is syndicated by a plurality of members of the sub-platform. As discussed above, the at least one of the offerings is for a plurality of securities made available for purchase by an issuing entity 112 over a network 109 via the securities offering application 100. In various embodiments, the at least one of the offerings may be made accessible via a network page 218 to facilitate a plurality of purchases of the securities by a plurality of users.

Accordingly, the securities offering application 100 also maintains a network presence for the issuing entity 112 offering securities for purchase. As discussed above, the securities offering application 100 is executed to facilitate the online purchase of securities over the network 209 (FIG. 2). The securities offering application 100 performs various backend functions associated with the online presence of an issuing entity 112 in order to facilitate the online purchase of securities offered by the issuing entity 112. For example, the securities offering application 100 generates network pages 218 such as web pages or other types of network content that are provided to client devices 206 for the purposes of selecting securities for purchase. In addition, the securities offering application 100 performs additional backend functions such as verifying legal compliance and conducting financial transactions between a purchaser and the issuing entity 112.

In 706, a description for an issuing entity 112 and/or an investment organization 109 is parsed to automatically assign one or more labels 106 to the issuing entity 112 or to the investment organization 109. The parsing of the descriptions may be performed periodically at predefined intervals to maintain an accurate listing of the labels 106 in the data store 103 for each issuing entity 112 or investment organization 109. As a non-limiting example, a sentence or a phrase set forth in a profile for an issuing entity 112 or an investment organization 109 may state “developing cloud computing storage solutions of the future” or “investing in cloud computing companies of the future.” The phrase may be parsed to identify that the issuing entity 112 or the investment organization 109 should be associated with the label 106 corresponding to “cloud computing” as the term appears in the phrase. Accordingly, an association between the label 106 and the issuing entity 112 or the investment organization 109 may be made in the data store 103. In place of or in addition to automatically assigning labels, labels 106 may be manually added or removed by the administrator of the issuing entity 112 or the investment organization 109.

In 709, the securities offering application 100 monitors various purchases of securities (as well as a lack of purchases of securities) for an issuing entity 112. For example, the issuing entity 112 may set a funding target of selling 100,000 equity securities at $10 per equity to obtain $1,000,000 in financing. The securities offering application 100 may monitor the purchases of the equity securities to determine whether the funding target has been met, as shown in 712. If the number of securities purchased meets or exceeds the threshold set forth by the administrator, the process may proceed to end. However, if the number of securities purchased does not meet or exceed the threshold, the securities offering application 100 may employ strategies to provide exposure to the securities offering on behalf of the issuing entity 112.

Accordingly, in 718, one or more investment organizations 109 may be determined that are similar to the issuing entity 112 offering the securities. Determining the one or more investment organizations 109 may be accomplished by the recommendation service 212 by comparing a first plurality of labels 106 associated with the entity to a second plurality of labels 106 associated with the investment organization 109. For example, if the issuing entity 112 is associated with a label 106 for “cloud computing,” the securities offering may be suggested to investment organizations 109 also associated with a label 106 for “cloud computing” and/or labels 106 similar to “cloud computing” such as “distributed computing.” As another example, if the issuing entity 112 is associated with the label 106 for “New York” (as the issuing entity 112 has previously stated that the issuing entity 112 is based in New York), the securities offering may be suggested to investment organizations 109 that invest in New York, such as the “New York Angel Investors” and similar entities, groups, or organizations.

In 721, the securities offering for the issuing entity 112 may be recommended to the investment organizations 109 identified in 718. Recommending the securities offering may include, for example, placing a component, such as a hyperlink, an advertisement, or a banner on a member page for the investment organizations 109, whereby the component is shown to the members of the investment organizations 109. For example, assuming a member of the “New York Angel Investors” logs in to the securities offering application 100, the display page for the investment organization 109 may contain a hyperlink, an advertisement, a banner, or a similar component that links to the network page 218 associated with the security offering by the issuing entity 112.

In various embodiments, in 724, the securities offering application 100 allows members of the investment organization 109 to syndicate an offering offered by the issuing entity 112 to another third party investment organization 109 or to the master platform on the securities offering application. To this end, the securities offering application 100 monitors votes, indications of interest, or investments or similar feedback. For example, the users may engage an “upvote” component or a “downvote” component associated with the hyperlink to crowdsource votes among its members as to whether the members like or dislike the securities offering. Assuming a favorable amount of votes have been obtained in association with the offering of the securities, an administrator for the investment organization 109 may view the result of the votes and/or offer the securities for purchase by the users of the applicable sub-platform.

According to various embodiments, the offerings in the securities offering application 100 may be monitored to determine whether at least one of the offerings is a “best deal” and should bubble up or surface to the master platform. For example, an offering that meets or exceeds a predefined amount of network traffic, social media traffic, securities purchases, etc., may be surfaced to a main index page for the securities offering application 100. In various embodiments, the “best deal” offering may be manually selected by an administrator of the securities offering application 100. Alternatively, according to various embodiments, a score may be assigned to each of the offerings and the offerings may be ranked according to their score to determine which offerings to surface in the securities offering application 100.

As may be appreciated, the investment organizations 109 operating their own sub-platform may have unique and distinct investor bases. However, all users of the platforms may have a master account at the master platform. For example, if a user signs up for an Atlanta Angel Investors sub-platform, the user becomes a member of the Atlanta Angel Investors and may also be made a member of the master platform. Similarly, if the user later decided to join New York Angel Investors, the user can apply to join the New York Angel Investors sub-platform using the same master platform profile.

Sub-platforms may be maintained by the securities offering application 100 for geographic regions (e.g., Atlanta, Seattle, New York, Silicon Valley, Hong Kong, etc.). However, each regional sub-platform may have a distinctive subset of users and administrators relative to the master platform

Syndication is described herein as deals being shared from one sub-platform to another. All the data will remain in a single investment object that can be accessed by each platform where the deal has been syndicated.

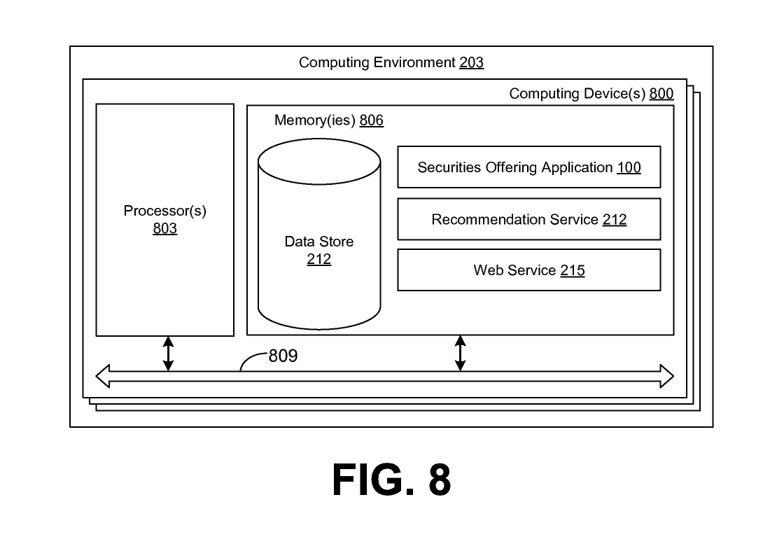

With reference to FIG. 8, shown is a schematic block diagram of the computing environment 203 according to an embodiment of the present disclosure. The computing environment 203 includes one or more computing devices 800. Each computing device 800 includes at least one processor circuit, for example, having a processor 803 and a memory 806, both of which are coupled to a local interface 809. To this end, each computing device 800 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 are the securities offering application 100, the recommendation service 212, the web service 215, and potentially other applications. Also stored in the memory 806 may be a data store 103 and other data. In addition, an operating system may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the securities offering application 100, the recommendation service 212, the web service 215, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 7 shows the functionality and operation of an implementation of portions of the securities offering application 100 and/or the recommendation service 212. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowchart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. Further, in some embodiments, one or more of the blocks shown in FIG. 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the securities offering application 100, the recommendation service 212, and the web service 215, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the securities offering application 100, the recommendation service 212, and the web service 215, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 800, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a securities offering application executable in at least one computing device, comprising:
code that maintains an interconnected network of platforms by a securities offering application, the interconnected network of platforms comprising:
a master platform managed by a master administrator of the securities offering application, the master platform comprising at least one network page accessed by a first network address configured to display a plurality of offerings;
a sub-platform associated with an investment organization, the sub-platform being managed by an administrator of the sub-platform and comprising a second network page accessed by a second network address configured to display at least one of the offerings that is syndicated by a plurality of members of the sub-platform; wherein the at least one of the offerings is for a plurality of securities made available for purchase by an issuing entity over a network via the securities offering application, the at least one of the offerings being accessible via a third network page configured to facilitate a plurality of purchases of the securities by a plurality of users;
code that determines whether a number of the securities purchased meets a predefined threshold configurable by an issuing entity administrator associated with the at least one issuing entity, the predefined threshold comprising at least a funding target for the at least one issuing entity; and
code that automatically recommends, in response to the number of the securities purchased not meeting the predefined threshold, the third network page that offers the securities for purchase to a different sub-platform maintained by the securities offering application, wherein the different sub-platform is determined based at least in part on a similarity of the sub-platform to the issuing entity offering the securities for purchase.

2. The non-transitory computer-readable medium of claim 1, wherein the similarity is determined based at least in part on a comparison of a first plurality of labels associated with the issuing entity offering the securities with a second plurality of labels.

3. The non-transitory computer-readable medium of claim 1, wherein the at least one of the offerings is syndicated by the members based at least in part on a vote conducted by the members associated with of the at least one of the offerings.

4. The non-transitory computer-readable medium of claim 2, wherein the second plurality of labels are associated with a previous purchase in which at least one of the investment organizations purchased at least one security from a similar entity.

5. A system, comprising:
at least one computing device; and
a securities offering application executed in the at least one computing device, the securities offering application comprising:
logic that maintains an interconnected network of platforms comprising:
a master platform comprising a first network page accessed by a first network address configured to display a plurality of offerings; and
a sub-platform associated with an investment organization comprising a second network page accessed by a second network address configured to display at least one of the offerings that is syndicated by a plurality of members of the sub-platform; and
wherein the at least one of the offerings is for a plurality of securities made available for purchase by an issuing entity over a network, the at least one of the offerings being accessible via a third network page configured to facilitate a plurality of purchases of the securities by a plurality of users.

6. The system of claim 5, wherein the securities offering application further comprises:
logic that determines whether a number of the securities purchased meets a predefined threshold; and
logic that recommends, in response to the number of the securities purchased not meeting the predefined threshold, the network page that offers the securities for purchase to at least one different sub-platform registered in the securities offering application.

7. The system of claim 6, wherein the predefined threshold further comprises a funding target for the entity.

8. The system of claim 6, wherein the at least one different sub-platform is determined based at least in part on a similarity of the at least one different sub-platform to the issuing entity offering the securities for purchase.

9. The system of claim 8, wherein the similarity is determined based at least in part on a comparison of a first plurality of labels associated with the issuing entity offering the securities with a second plurality of labels.

10. The system of claim 9, wherein the second plurality of labels are associated with a previous purchase in which the at least one different sub-platform purchased at least one security from a similar issuing entity.

11. The system of claim 9, wherein the securities offering application further comprises logic that adds at least one of the plurality of offerings manually to the first network page of the master platform based at least on a popularity of the at least one of the offerings.

12. A method, comprising:
maintaining, by at least one computing device, an interconnected network of platforms comprising:
a master platform comprising a first network page accessed by a first network address configured to display a plurality of offerings; and
a sub-platform associated with an investment organization comprising a second network page accessed by a second network address configured to display at least one of the offerings that is syndicated by a plurality of members of the sub-platform, wherein the at least one of the offerings is for a plurality of securities made available for purchase by an issuing entity over a network, the at least one of the offerings being accessible via a third network page configured to facilitate a plurality of purchases of the securities by a plurality of users; and
determining, by the at least one computing device, whether a number of the securities purchased meets a predefined funding target.

13. The method of claim 12, wherein the predefined threshold is configurable by an administrator of the issuing entity via the securities offering application.

14. The method of claim 12, wherein the at least one investment organization is determined based at least in part on a similarity of the at least one investment organization to the entity offering the securities for purchase.

15. The method of claim 14, wherein the similarity is determined based at least in part on a comparison of a first plurality of labels associated with the entity offering the securities with a second plurality of labels.

16. The method of claim 17, wherein the second plurality of labels are manually predefined by the at least one third-party investment entity.

17. The method of claim 15, wherein the second plurality of labels are associated with a previous purchase in which the investment organizations purchased at least one security from a similar entity.

18. The method of claim 12, further comprising adding, by the at least one computing device, at least one of the plurality of offerings automatically to the first network page of the master platform based at least on a popularity of the at least one of the offerings.

19. The method of claim 12, wherein the at least one of the offerings is syndicated by the members based at least in part on a vote conducted by the members associated with of the at least one of the offerings.

20. The method of claim 17, wherein the securities offering application further comprises maintaining, by the at least one computing device, a plurality of collaboration components accessible by the users to communicate across the interconnected network of platforms.
